(19) United States
(12) Patent Application Publication
(10) Pub. No.: US 2006/0055945 A1
(43) Pub. Date: Mar. 16, 2006

(54) Color-mapped data display

(76) Inventor: William B. Fazakerly, Pleasanton, CA (US)

Correspondence Address: William B. Fazakerly, 4967 Dolores Drive, Pleasanton, CA, 94566, US

(21) Appl. No.: 10/939,325

(22) Filed: Sep. 13, 2004

(51) Int. Cl. G06F 15/00

(52) U.S. Cl. 358/1.9

(57) ABSTRACT

Disclosed is a method of data presentation that uses color to facilitate the analysis of displayed data. The invention is particularly useful when applied to data analysis for process control, but it may also be applied to any data collection application where sampled data values should lie within a range of values and should ideally be clustered around an optimum point within that range of values. The invention facilitates qualitative analysis of tabular data to determine whether data values cluster around the optimum point within the range, whether those data values approach the limits of the range or fall outside of the range, and whether the spread in those data values is increasing or decreasing.

### CROSS REFERENCE TO RELATED APPLICATIONS

None

### STATEMENT REGARDING FEDERALLY SPONSORED RESEARCH

None

### REFERENCE TO SEQUENCE LISTING OR PROGRAM LISTING

None

### BACKGROUND OF THE INVENTION

Although applicable to many data collection and analysis applications, the present embodiment of the invention is being applied to Statistical Process Control (SPC). SPC is a quality assurance discipline that attempts to identify those parameters or “process variables” that affect product quality, establish methods to measure those variables, determine the limits on those measured values that will ensure acceptable product, determine the frequency of measurement necessary to ensure that all process variables remain within their limits, and continually correlate the measured values to product quality in order to refine measurement methods, frequency and limits. It follows that a key component of SPC is the measurement, recording, and analysis of process variables to ensure that they remain within limits and that product quality remains acceptable.

In response to the recent emphasis of product quality and the widespread adoption of SPC, computer programs have been developed to aid data collection and analysis of process data. These tools generate a number of different “control charts” to characterize and summarize accumulated process data. Such charts include X-bar-R charts (to show the average values and ranges of a measured process variable), normalized distributions (to show how measurements are distributed throughout a range of values), and many other types of graphical and textual reports. These control charts are complex. Moreover, the control charts presently available to summarize process data are disjoint from the process data in its tabular form; the most natural form of accumulated data and the form that is most readily connected to the discrete measurement events. Finally, these control charts and reports are normally produced by a “post-processing” step—often operating off-line on files of stored data—due to the need to process all of the accumulated data and the time required to calculate the statistics. Because of the complexity of statistics, the disjoint nature of tabular data and control charts, and the post processing required for generation of statistics, these tools are difficult to use—especially for those who are not thoroughly trained in quality control and statistical analysis.

### BRIEF SUMMARY OF THE INVENTION

Color mapping of a data display is done by assigning a particular color to a particular range of data values in such manner that changes in color are related to concomitant changes in data. The colors are then embedded into a tabular display as a font color, cell background color, or other indicator thereby allowing the simultaneous display of a numeric data value and the color that is mapped to that data value. These mapped colors are also useful as a method of qualitatively linking various forms of quantitative displays, such as control charts, to the tabular data.

Color mapping of a data display improves upon the state of the art in three ways. First, it conveys a qualitative summary of collected process data without relying upon the specialized terminology of statistics. Secondly, it creates a visual and intuitive connection between data in tabular form and that same data in the form of control charts and summary graphs. Finally, since color mapping is accomplished with a simple algorithm that can be applied to subsets of the accumulated data, very little processing overhead is required.

### BRIEF DESCRIPTION OF THE SEVERAL VIEWS OF THE DRAWING

The patent or application file contains at least one drawing executed in color. Copies of this patent or patent application publication with color drawing(s) will be provided by the Patent and Trademark Office upon request and payment of the necessary fee.

FIG. 1. Mapping Spectrum to Ranges shows the color spectrum and mapping that is used in the present embodiment of the invention.

FIG. 2. Alternative Spectra shows three different color spectra that have been mapped to data values in various embodiments of the invention.

FIG. 3. Tabular Data without Color Mapping shows tabular data without any color used to augment the textual representation of the data values.

FIG. 4. Tabular Data with Color Mapping shows tabular data with colors from the spectrum of FIG. 1 used to augment the textual representation of the data values.

FIG. 5. Color-Mapped Table and Normalized Distribution shows tabular data with colors from the spectrum of FIG. 1 used to augment the textual representation of the data values in the table and to link the tabular values to their location in the distribution.

FIG. 6. Color-Mapped Table with Out-of-Range Readings shows tabular data with colors from the spectrum of FIG. 1 where certain of the data values are out-of-range.

FIG. 7. Color-Mapped Table and Time Sequenced Distributions shows tabular data with colors from the spectrum of FIG. 1 used to augment the textual representation of the data values in the table and to link the tabular values to their location in two distributions, where each of the distributions includes data values from different time periods.

### DETAILED DESCRIPTION OF THE INVENTION

Software to monitor chemical baths has been developed for use in a metal plating company. This software uses color-mapped displays to communicate the status of process variables, and it has been an important part of an ISO-certified quality management system. We will use an example from this chemical monitoring application to describe this embodiment of the invention and to show how it has been used to improve process control and product quality.

The parameters that characterize a chemical bath include pH, baumé, temperature, specific gravity, and the concentrations of the various chemical constituents that make up the bath. Each of these parameters is a process variable in the plating process since it affects the quality of the product, and it cannot be held constant during the process. The variables have operating limits that are established by a combination of plating experience, manufacturer's recommendations, and continual refinement by SPC. To demonstrate the color-mapped display method, we will use one of these process variables as an example: the gold concentration in a gold-plating bath. Since the gold in a gold-plating bath is used up by the plating process, gold salt must be added to the bath to maintain concentration. The frequency of testing must be sufficient to ensure that the gold concentration does not drop below the lower operating limit before gold salt is added to the bath to bring the gold concentration back above optimum. As tests of concentration and subsequent additions are performed over time, the test results must be recorded and analysis done to determine if adjustments should be made to the frequency of testing or to the operating limits, to determine if chemical additions are being done properly, and to correlate chemical bath variations to product test results such as plating thickness, appearance and adhesion.

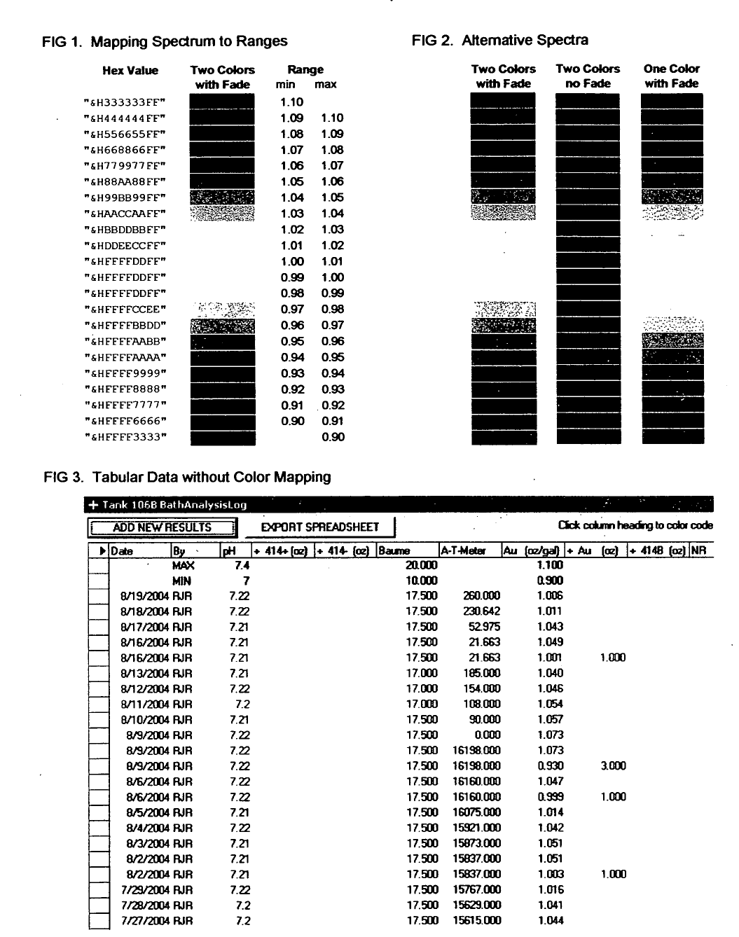

The optimum gold concentration in the example gold-plating bath is 1.0 ounces per gallon, and the operating limits are 0.9 ounces per gallon on the low end and 1.1 ounces per gallon on the high end. To set up the color-mapped display for this particular variable, the range from 0.9 to 1.1 is divided into some number of equal segments, and each of these segments is mapped to a particular color. This is shown in the Range columns of FIG. 1 with the operating range of the gold-plating bath divided into 20 equal segments, each segment being 5% of the total range. FIG. 1 also shows the color spectrum that is mapped to the various data value ranges. Some of the other color spectra that have been used for this application are shown in FIG. 2. The One Color with Fade spectrum of FIG. 2 is useful for variables that cannot drift outside one of the limits (for example, when one limit is zero), or for applications where it is desired to determine deviation from optimum without showing the direction of the deviation. For monitoring chemical concentrations in plating baths, we selected the Two Colors with Fade spectrum shown in FIG. 1 so that readings approaching the maximum limit can be distinguished from those approaching the minimum limit and to accentuate readings that approach the limits. In FIG. 1, we have shown the hex codes that represent colors in the Windows XP operating system. This color representation uses pairs of hex characters to indicate the relative strength of the red, green and blue (RGB) color components. The bright red color that we are using to represent the out-of-range high values is represented by the hex value 333333FF. We selected a bright blue to represent out-of-range values on the low side: these are values less than 0.9 ounces per gallon in the example of the gold-plating bath. This bright blue color is represented by FFFF3333. A comparison of these hex values shows that, as the color changes from red to blue, the first four characters transition from 3333 to FFFF, while the last two characters transition from FF to 33. It is these gradual changes in color that track the gradual changes in data values. Violet is the color equidistant from red and blue, as shown in the Two Colors with No Fade column of FIG. 2. However, the other two characters must transition in steps from hex 33 to hex DD at mid-range and then back again to hex 33 to fade the violet color. Although it is possible to use arithmetic to transform a data value into a color value, the present embodiment uses a lookup table approach. The basic algorithm is as follows:
1. Assign the color values to a variable array. In the Visual Basic language, this array is declared as follows: Dim Color(21) As String. In this array, Color(0) and Color(21) are assigned the hex values corresponding to the out-of-range colors and Color(1) through Color(20) correspond to data values that fall within operating limits.
2. Break the data value range into sub-ranges that will be mapped to the colors in the Color(21) array using a second array that is declared as Dim Range(21) As String.
3. Using a For loop of the form For i=0 to 21, step through each of the stored data values and compare the data value to the maximum and minimum value of each sub-range until a match to is found to Range(N). When the match is found, the background color of the cell in the data grid holding the data value is assigned Color(N).
   Note in FIG. 1 that the rate of change in color intensity increases as the data values approach the half-way point between the optimum and the limit since the objective in this application is to maintain gold concentration values within 50% of the total operating range around the optimum point. The colors corresponding to near-optimum values are clustered around a very light violet and transition quickly to intense red or blue half way between the optimum point and the operating limits.

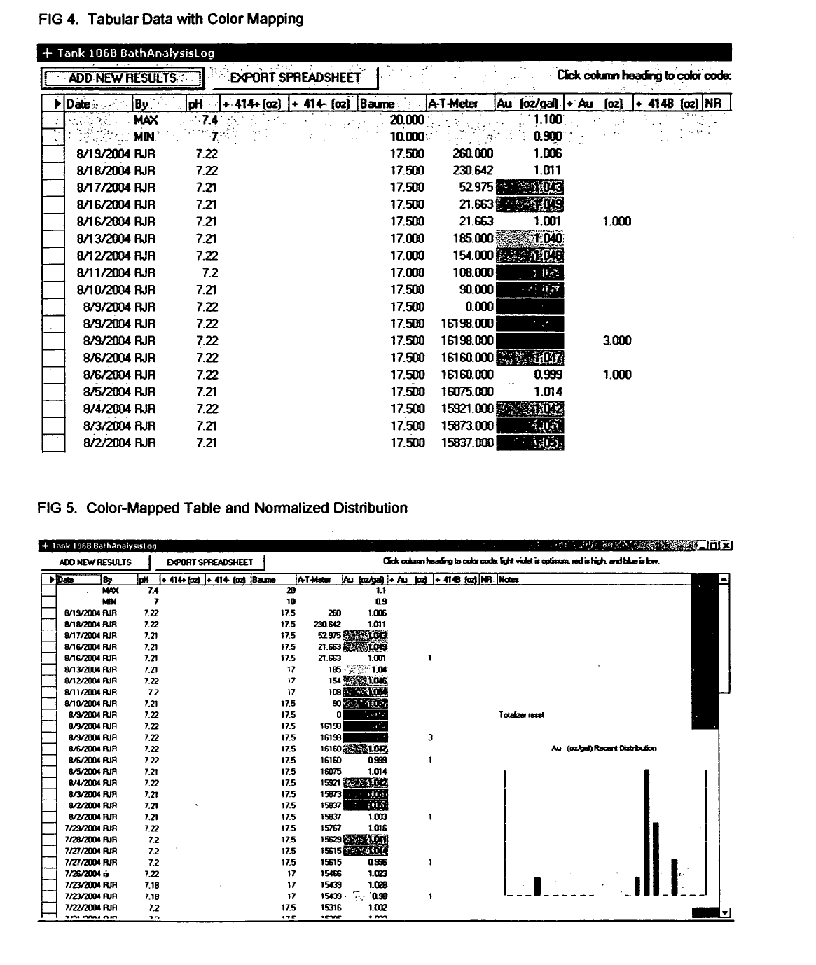

FIG. 3 shows a listing of gold-plating bath data without any color mapping: the gold concentration shown in the Au (oz/gal) column is a list of numbers that is quite difficult to interpret. Mental arithmetic must be done to determine where the value falls in the range, and this is quite difficult for a human user. When the color-to-data-value mapping shown in FIG. 1 is applied to the cell background of a displayed data file, the resulting display shows where the values deviate from optimum, and also shows which readings approach the upper and lower limits of the range. This makes it easy for a human reader to visually interpret the data. This visual interpretation can be done very quickly, without the aid of post-processing analysis tools, and can often obviate the need for such post-processing. For example, FIG. 4 shows the same tabular data from the gold-plating bath with the cells in the gold concentration column color mapped to the data value contained within the cell using the mapping shown in FIG. 1. With these color-mapped cell backgrounds, the gold concentration data can be quickly evaluated by simply scrolling through the file. The blue background makes it immediately obvious that the data recorded on Aug. 9, 2004 is a low value. This particular low data point was caused by a poor correlation between estimates of bath concentration using amp-time and an actual atomic absorption test. The blue cell on Aug. 9, 2004 is followed by two cells with a red background indicating a high concentration. These two high readings were due to an addition of 3 ounces of gold salt, as shown in the +Au(oz) column: this amount was too large and raised the concentration too far above optimum. This particular event in the history of the gold-plating bath shows how color mapping aids process control: we were able to find that an adjustment was needed in the conversion factor from amp-time to gold usage, and that a correction was needed in the calculation of ounces of gold per gallon of solution. Without this invention, it is unlikely that either of these needed corrections would have been found. Certainly, problematic events like this are not easily found from the usual statistical parameters because these statistics are disjoint from the discrete measurements of data value.

FIG. 5 shows how color mapping has been used to provide an intuitive link between tabular data and other forms of display. To provide this linkage, the color mapping that is applied to the tabular data is also applied as a color code to a summary display. The color-mapped tabular data shows each data point in sequence, while the color-coded summary groups the data points into some other format such as a time line, distribution, or other form of control chart. The simple example in FIG. 5 shows color-mapped sequential data from the gold-plating bath and the corresponding distribution of readings within the operating range. Each bar in the distribution graph in the lower right hand corner of FIG. 5 shows the number of gold concentration readings within each of the 20 ranges of FIG. 1. This is a normalized graph showing the relative counts, so the actual numbers are not shown. Since the color-coded bars on the distribution graph match the color-mapped cell backgrounds on the tabular data, the linkage between these two displays is intuitively obvious. For example, it is obvious that the data value from the blue-colored cell at Aug. 9, 2004 is shown in the leftmost bar of the distribution graph because the color of this left-most bar matches the color of the cell background in the tabular data recorded on Aug. 9, 2004. It is also clear that this reading from Aug. 9, 2004 is abnormal because all of the other recent readings are on the high side of optimum as shown by the red coloring and the position of the bars in the graph.

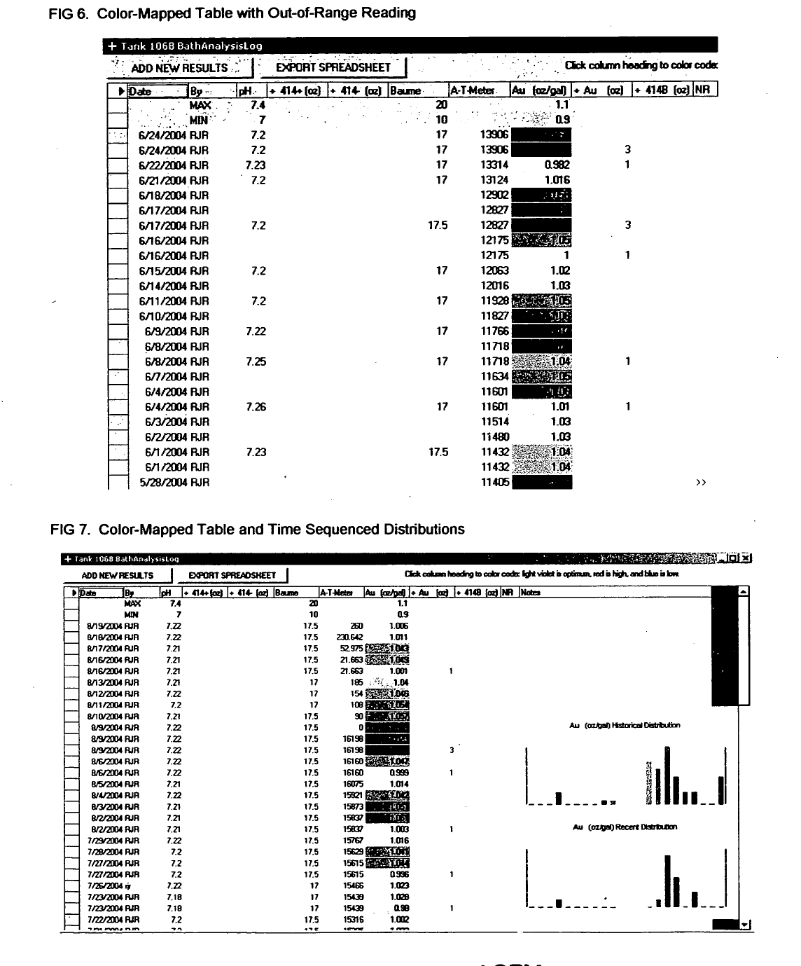

In addition to making out-of-range readings obvious, a color-mapped tabular display allows qualitative trend analysis. FIG. 6 shows a one month time span in the life of the gold-plating bath. The color mapping shows that a few high readings were taken in late May, followed by a period where the gold concentration was maintained close to optimum, and followed by a period where a few low readings were taken. This quick, qualitative trend analysis is easily done by visually scanning the color of the cell backgrounds. Trend analysis can be aided by using summary displays that include various subsets of the tabular data. FIG. 7 shows two color-coded distributions that are linked to the color-mapped tabular data from the gold-plating bath. The bottom right-hand graph shown in FIG. 7 shows the recent data points and corresponds to the graph shown in FIG. 5, while the upper graph shows the entire history of gold-concentration data values. Comparison of the two graphs shows that the recent low reading, shown by the leftmost blue bar on the bottom graph, is one of many low readings shown by the leftmost blue bar on the top graph. All of the low readings have been at least 10% inside the minimum limit of the operating range. Moreover, while there have been no recent readings that are within 10% of the maximum limit of the operating range, as shown on the bottom graph, a number of historical readings have been out-of-range on the high side as shown in the bright red bar in the far right position on the top graph. The older out-of-range readings can be quickly found by scrolling through the data grid; one of the out-of-range readings was taken on May 28, 2004 as shown in FIG. 6.

From the detailed description of the preferred embodiment and reference to the drawings, the significant advantages of color-coding tabular data and linking it to other forms of display are obvious. Those possessing general skill in the art will recognize the opportunity to introduce certain useful variations and modifications, and all of such variations and modifications are deemed to be within the scope of the present invention.

1. A method for displaying measured data values representing process variables in a process control application where colors are mapped to data values in a manner that allows said colors to visually indicate the relative magnitude of said data values.

2. A method for displaying measured data values representing process variables where data values are algorithmically converted to codes representing a color in a numeric scheme of representing colors, and said numeric code is then used to control font color, background color, or in some other manner to replace the numerical representation of said data values, to augment the numerical representation of said data values, or to establish a visual linkage between two forms of displaying said data values.

3. A method for displaying measured data values representing process variables in a process control application where a color is mapped to a data value by selecting said color from a range of colors where the individual colors within said range of colors, or some attributes of the individual colors in said range of colors, transition in relationship to the transition in the magnitude of said data values, such that changes in said colors visually indicate changes in said data values.

4. A method for displaying data as in claim 3 where the ending colors of said color range are mapped to the maximum, minimum, mid-point, optimum or other singular data values within said range of data values, and the colors between said ending colors are mapped to the data values within said range of data values such that the changes in color between said ending colors is proportional to the changes in the value of the data between said singular data values, and said colors are then used as cell background, font color, or in some other manner to augment or replace the numerical representation of the data value that was mapped to the color when said data is displayed in tabular form, graphical form, or other display form.

5. A method for displaying data as in claim 3 where said mapped colors are used as the font colors, the cell background colors, or in some other manner within a tabular listing of said data values, and said mapped colors are simultaneously used in some other form of display (such as bar graphs or line charts) to link said data values in tabular form to the representation of the data values in another graphical form.

6. A method as in claim 5 where said tabular form is the actual database table which is used to hold the data values as they are collected.

7. A method as in claim 5 where said other form of display is a normalized distribution in a bar graph, chart or other graphical form where each bar, point, or line in graphical form is filled, bordered or otherwise marked with said mapped color that has been mapped to said data values.

8. A method for displaying data as in claim 1 where data values are grouped into some number of value ranges, and a line, bar, point or other indicator on a graph showing the number of data points within each of said ranges is filled or bordered by the color from the palette that corresponds to the range.

9. A method for displaying data as in claim 1 where the data values are plotted on a time scale and the line, bar, point, background or other indicator on the plot is filled with, bordered by, or otherwise uses the color that has been mapped to the value of the data point to identify the data point.
